(19) United States
(12) Patent Application Publication
(10) Pub. No.: US 2003/0131118 A1
(43) Pub. Date: Jul. 10, 2003

(54) Apparatus for managing networks operated by different protocols and method thereof

(76) Inventor: Sung Hee Lee, Kunpo-shi (KR)

Correspondence Address: HARNESS, DICKEY & PIERCE, P.L.C., P.O. BOX 8910, RESTON, VA, 20195, US

(21) Appl. No.: 10/337,881

(22) Filed: Jan. 8, 2003

(30) Foreign Application Priority Data
Jan. 10, 2002 (KR) P 2002-1363

(51) Int. Cl. G06F 15/16

(52) U.S. Cl. 709/230; 709/249; 709/246

(57) ABSTRACT

Disclosed are an apparatus for managing networks operated by different protocols and a method thereof enabling a manager operated by a predetermined protocol to manage operations of a plurality of agents operated by another protocol different from the protocol of the manager. The present invention provides an SNMP gateway agent enabling an operation regardless of a kind of a network protocol for communications between an SNMP manager operated by one network protocol and SNMP agents operated by another network protocol. The SNMP gateway agent should connects the SNMP manager to the SNMP agents, thereby having two different network interfaces.

This application claims the benefit of the Korean Application No. P2002-1363 filed on Jan. 10, 2002, which is hereby incorporated by reference.

### BACKGROUND OF THE INVENTION

1. Field of the Invention

The present invention relates to an apparatus for managing networks operated by different protocols and a method thereof enabling a manager operated by a predetermined protocol to manage operations of a plurality of agents operated by another protocol different from the protocol of the manager.

2. Discussion of the Related Art

Generally, network management is based on the communication of specific information between one system operating as a manager and the other system operating as an agent. Specific information and sources to be managed are called ‘objects’, and an aggregate of the objects is called ‘MIB (management information base)’. Managing networks means that a manager reads a specific value from MIBs provided by agents as the objects to grasp a status of the corresponding agent as well as change the specific value. The change of the specific value means the change of a character string or a numeric of the corresponding MIB as well as the change of the status of the corresponding agent through the change of the value or a predetermined command for the agent.

Initial Internet network management of TCP/IP environment grasps a linking state between terminal equipments using ICMP (Internet control message protocol) through ping, which just provides information about whether a host of the other party operates or a function of measuring a response time.

Recently, the number of hosts linked to Internet increases greatly and the structure of networks gets more complicated, whereby new protocol standards are demanded. To meet such a demand, IAB (Internet architecture board) adopts SNMP (simple network management protocol) as a standard.

The SNMP provides easy understanding and implementation, has a small size of a corresponding agent, and facilitates an extension of MIB as a database of a management object. Hence, the SNMP expands its application fields continuously. Moreover, an SNMP PDU (protocol data unit) has a structure facilitating transplantation of another network protocol. Hence, the SNMP is applicable to various networks based on ISO CLNP (connectionless network protocol), apple talk DDR (datagram delivery protocol), Novell IPX (internetwork packet exchange) as well as TCP/IP. Besides, the SNMP is expected to adapt to new network protocols with ease.

Many movements of improving functions and efficiencies by linking various equipments, i.e., a plurality of SNMP agents, to networks and unifying to manage the SNMP agents remotely are brought about in various fields. For instance, the SNMP is applicable to a home network connecting home appliances to each other. In general, an intrinsic network protocol exists in each field. Yet, the SNMP agent has no concern in what network protocol is. This is because the SNMP PDU has the excellent transplantation characteristic to be applicable to various networks connecting a plurality of the SNMP agents.

However, the SNMP manager has difficulty in managing a plurality of the SNMP agents. Namely, the most widely used network protocol is practically TCP/IP and the commercialized SNMP managers are mostly based on TCP/IP. It is of course that the SNMP manager is modified to fit the corresponding network protocols of a plurality of the SNMP agents. Yet, the following problems are brought about.

Firstly, the SNMP manager has functions more complicated than those of a plurality of the SNMP agents, thereby requiring a long development time and lots of cost. If what to be developed are SNMP equipments, such burdens are of no use.

Secondly, even if an SNMP manager is developed to fit a specific network protocol, it just plays a role of a local manager limited to the corresponding field and specific network protocol. Namely, the SNMP manager has difficulty in managing the SNMP agents beyond the general network such as Internet. To make it possible, a device of transforming the protocols is necessary.

Even if the SNMP manager based on the specific network protocol is developed by paying expensive costs, the SNMP manager is only used as the local manager limited to the local network. Hence, in aspects of cost and management, it is more efficient to use the SNMP manager based on the previously developed and commercialized TCP/IP.

In aspect of such a background, a communication system between the TCP/IP based SNMP manager and the SNMP agent having new protocol applied thereto should be considered.

When the TCP/IP based SNMP manager manages the SNMP agents over other network protocols, some factors should be considered in IP address allocation. The TCP/IP -based SNMP manager identifies the SNMP agents with IP addresses. However, it is a waste of IP resources that IP addresses are allocated to the SNMP agents operating based on other network protocols in order to identify the SNMP agents only. Hence, instead of IP, another method of identifying the SNMP agents is requested.

### SUMMARY OF THE INVENTION

Accordingly, the present invention is directed to an apparatus for managing networks operated by different protocols and a method thereof that substantially obviate one or more problems due to limitations and disadvantages of the related art.

An object of the present invention is to provide an apparatus for managing networks operated by different protocols and a method thereof enabling to manage a plurality of SNMP agents operating over another network protocol except TCP/IP using an SNMP manager based on the TCP/IP.

Another object of the present invention is to provide an apparatus for managing networks operated by different protocols and a method thereof requiring no additional treatment on an SNMP manager or SNMP agents for the communication between the SNMP manager and the SNMP agents operated by different network protocols respectively.

A further object of the present invention is to provide an apparatus for managing networks operated by different protocols and a method thereof enabling an SNMP manager to manage a plurality of SNMP agents with a single interface.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

The present invention is characterized in that an SNMP gateway agent enabling an operation regardless of a kind of a network protocol is provided for communications between an SNMP manager operated by one network protocol and SNMP agents operated by another network protocol. The SNMP gateway agent should connect the SNMP manager to the SNMP agents, thereby having two different network interfaces.

Moreover, provided is the SNMP gateway having all the data and functions necessary for communications between an SNMP manager and SNMP agents operating over different network protocols, respectively. Therefore, functions of the SNMP manager or the SNMP agents need no modification.

Besides, an MIB (management information base of the SNMP gateway agent is provided with MIBs of a plurality of the SNMP agents. Hence, the SNMP manager regards each of the SNMP agents as a portion of the SNMP gateway agent. Therefore, the SNMP manager enables to manage a plurality of the SNMP agents using a single IP address.

To achieve these objects and other advantages and in accordance with the purpose of the invention, as embodied and broadly described herein, a method of managing networks operated by different protocols according to the present invention includes the steps of having an SNMP (simple network management protocol) gateway agent receive an SNMP packet generated by an SNMP manager, having the SNMP gateway agent judge whether the SNMP packet received by the SNMP gateway agent is an SNMP packet for managing a plurality of SNMP agents operated by a network protocol different from that of the SNMP manager or not, having the SNMP gateway agent transform the SNMP packet into the network protocol operating a plurality of the SNMP agents to transmit to a plurality of the SNMP agents if it is judged that the received SNMP packet is the SNMP packet for managing a plurality of the SNMP agents, having a plurality of the SNMP agents treat the transmitted SNMP packet and transmitting the treated SNMP packet to the SNMP gateway agent, having the SNMP gateway agent receive the transmitted SNMP packet, transforming the received SNMP packet into a protocol operating the SNMP manager, and transmitting, the transformed SNMP packet to the SNMP manager; and having the SNMP manager receive the transmitted SNMP packet to treat.

Preferably, the step of having the SNMP gateway agent judge is carried out based on an OID (object identification) that the SNMP gateway agent reads from the SNMP packet received from the SNMP manager.

More preferably, the SNMP gateway agent further reads an address of the corresponding SNMP agent that will transmit the SNMP packet from an OID agent address mapping table based on the read OID.

Preferably, the SNMP manager and the SNMP gateway agent transmit the SNMP packet reciprocally through a TCP/IP based Internet network.

In another aspect of the present invention, a method of managing networks operated by different protocols includes a first step of having an SNMP (simple network management protocol) gateway agent receive an SNMP packet generated by an SNMP manager, a second step of having the SNMP gateway agent judge whether the received SNMP packet is an SNMP packet for managing a plurality of SNMP agents operated by a network protocol different from that of the SNMP manager or not, and having the SNMP gateway agent treat the SNMP packet to transmit the treated SNMP packet to the SNMP manager if it is judged that the received SNMP packet is an SNMP packet for the SNMP gateway agent itself.

Preferably, the second step is carried out based on an OID (object identification) that the SNMP gateway agent reads from the SNMP packet received from the SNMP manager.

Preferably, the SNMP manager and the SNMP gateway agent transmit the SNMP packet reciprocally through a TCP/IP based Internet network.

In a further aspect of the present invention, an apparatus for managing networks operated by different protocols includes a plurality of SNMP agents operated by a predetermined network protocol, an SNMP manager managing operations of a plurality of the SNMP agents, the SNMP manager operated by another protocol different from the network protocol of a plurality of the SNMP agents, and an SNMP gateway agent installed between the SNMP manager and a plurality of the SNMP agents, the SNMP gateway agent transforming a protocol of an SNMP packet transmitted reciprocally between the SNMP manager and a plurality of the SNMP agents to carry out an interfacing.

Preferably, the SNMP gateway agent stores an OID agent address mapping table enabling an address of the corresponding SNMP agent of the received SNMP packet to be read based on an OID read from the SNMP packet received from the SNMP manager.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a diagram of a general construction of a managing apparatus according to the present invention;

FIG. 2 illustrates an OID (object identification) address mapping table stored previously in an SNMP gateway agent according to the present invention;

FIG. 3 illustrates a diagram of an SNMP packet transmitted in the present invention; and

FIG. 4A and FIG. 4B illustrate signal flowcharts of operations according to a managing method according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

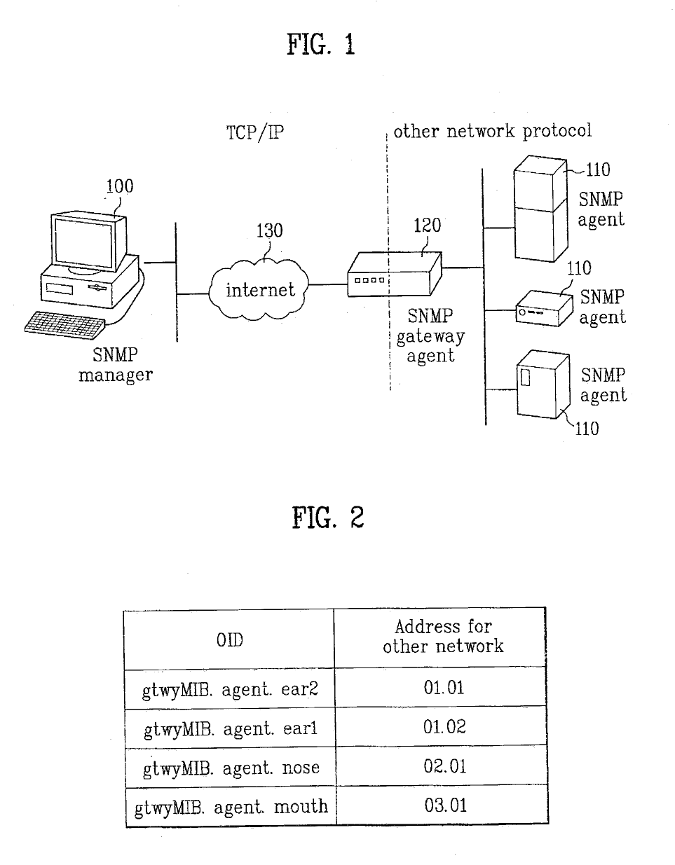

FIG. 1 illustrates a diagram of a general construction of a managing apparatus according to the present invention, in which a numeral ‘100’ indicates an SNMP (simple network management protocol) manager based on a predetermined protocol such as TCP/IP and a numeral ‘110’ represents a plurality of SNMP agents operated by a network protocol different from that of the SNMP manager 100.

Referring to FIG. 1, between the SNMP manager 100 and a plurality of the SNMP agents 110, an SNMP gateway agent 120 is installed to interface SNMP packets to enable communications between them. And, the SNMP manager 100 and the SNMP gateway agent 120 are connected to each other to enable a data communication reciprocally through Internet networks 130.

In the above-constituted managing apparatus according to the present invention, the SNMP gateway agent 120 has a couple of network interfaces. One is a TCP/IP interface for connection to the SNMP manager 100 through the Internet 130, and the other is an interface to another network linked to a specific product group, i.e., a plurality of the SNMP agents 110. Hence, if an SNMP packet of TCP/IP transmitted by the SNMP manager 100 corresponds to one of a plurality of the SNMP agents 110, the SNMP packet is transformed into the network protocol of the SNMP agents 110 to transmit to one of a plurality of the SNMP agents 110. And, the SNMP packet transmitted by one of the SNMP agents 110 is transformed into the TCP/IP as the protocol of the SNMP manager 100 to transmit to the SNMP manager 100.

Moreover, MIP (management information base) stored previously in the SNMP gateway agent 120 is largely divided into two parts. One part has no relation to the operation that the SNMP gateway agent 120 operates as a gateway agent, and includes system MIB, interface MIB. And the like. The other part is a gateway MIB having information required for operating as the gateway agent. The gateway MIB basically includes a unit of playing a role of a root of agent MIBs and an OID (object identification) agent address mapping table.

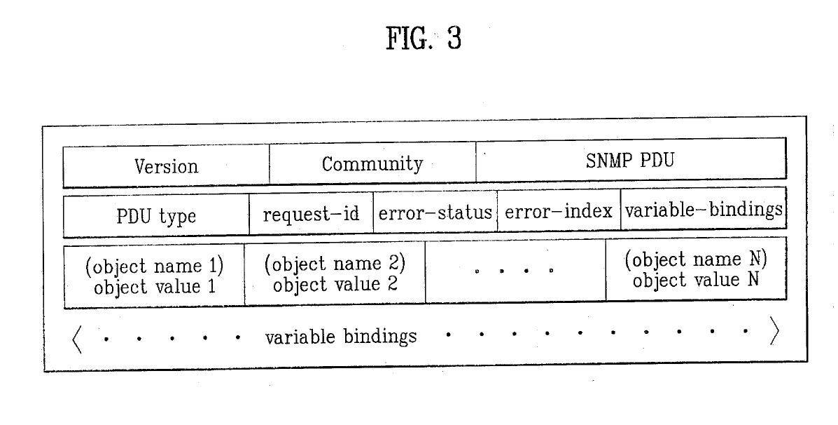

FIG. 2 illustrates an OID (object identification) address mapping table stored previously in an SNMP gateway agent according to the present invention.

Referring to FIG. 2, MIB of each of the SNMP agents should be disposed below “gtwyMIB.agent”. Namely, a root OID of each of the agent MIBs must be ‘gtwyMIB.agent”. By the above-explained way of definition, the OID of each of the agent MIBs can be used as an ID enabling to identify the corresponding SNMP agent 110 as well as a plurality of the lower SNMP agents 110 can be managed using a single IP.

Once the SNMP packet transmitted through the Internet network 130 from the SNMP manager 100 is received by the SNMP gateway agent 120, the SNMP gateway agent 120 reads the OID from the received SNMP packet.

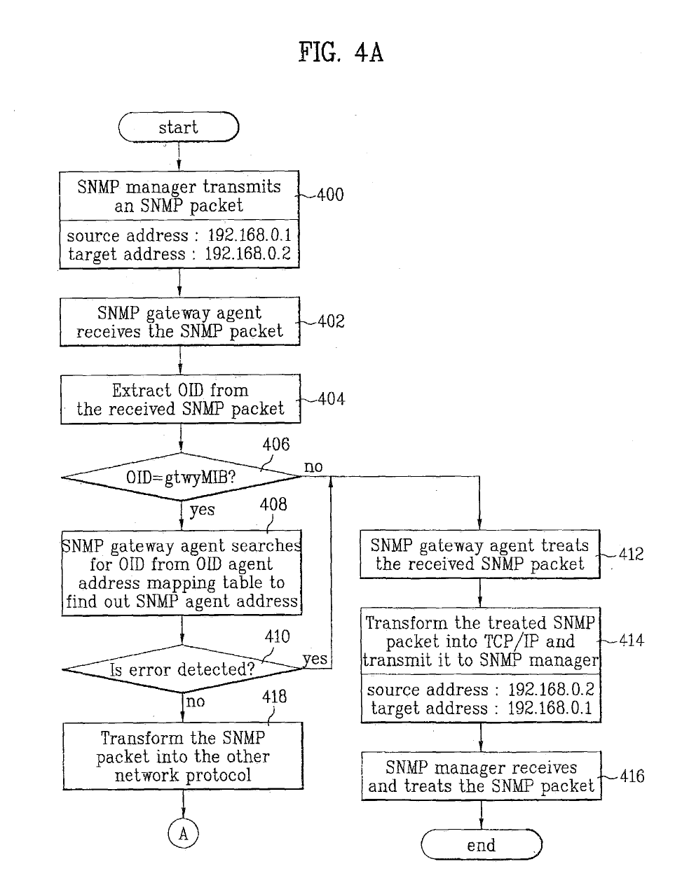

The SNMP packet, as shown in FIG. 3, for example, includes version, community, SNMP PDU, PDU type, request ID, error status, error index, variable bindings, and a plurality of object values (object value 1−object value N). And, the SNMP gateway agent 120 reads the OID in the SNMP PDU of the SNMP packet.

As a result of reading the OID, if the OID corresponds to a subordinate of “gtwyMIN.agent”, the SNMP packet is a packet to transmit to the agent over another network. Hence, another MIB process is carried out to transmit the packet to the SNMP agent operated by the corresponding network protocol. On the other hand, if the OID fails to correspond to the subordinate of the “gtwyMIN.agent”, it is the MIB of the SNMP gateway agent 120 itself, i.e., a request for the MIB having no relation to the original role of the SNMP gateway agent. Hence, the SNMP gateway agent 120 carries out the MIB process of its own.

In the another MIB process, the SNMP gateway agent 120 searches the OID agent address mapping table to judge whether an OID matching the foregoing OID exists or not. If there exists the matched OID, the SNMP gateway agent 120 uses an address of the corresponding SNMP agent 110 as a target address and generates an SNMP packet according to the corresponding network protocol. The SNMP gateway agent 120 then transmits the SNMP packet to the SNMP agent 110 through the corresponding network interface. The transmitted SNMP packet is processed by the SNMP agent 110.

Moreover, when a predetermined SNMP packet is transmitted from the SNMP agent 110 to the SNMP gateway agent 120, the SNMP gateway agent 120 receives the SNMP packet to transform into TCP/IP. The SNMP gateway agent 120 then transmits the TCP/IP-transformed SNMP packet to the SNMP manager through the Internet network 130.

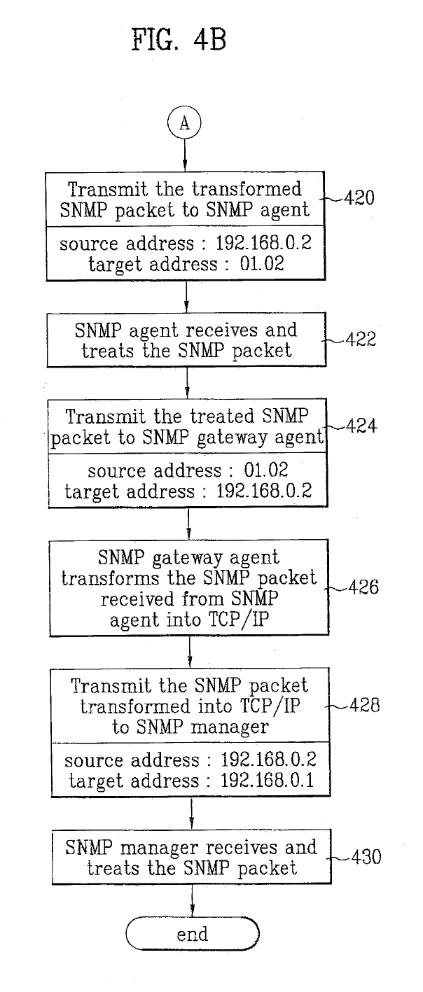

FIG. 4A and FIG. 4B illustrate signal flowcharts of operations according to a managing method according to the present invention.

Referring to FIG. 4A and FIG. 4B, in a step 400, the manager 100 generates a predetermined SNMP packet that will manage predetermined SNMP agents 110 and then transmits the generated SNMP packet through the Internet network 130 by making its address be a source address and making an address of the SNMP gateway agent 120 be a target address. For instance, the SNMP manager 100 has the source address of 192.168.0.1 and the target address of 92.168.0.2 to transmit the SNMP packet that will mange the predetermined SNMP agents 110.

The predetermined SNMP packet transmitted by the SNMP manager 100 is received by the SNMP gateway agent 120 having the address of 192.168.0.2 in a step 402. The SNMP gateway agent 120 reads an OID inserted in an SNMP PDU of the received SNMP packet in a step 404. For instance, the SNMP gateway agent 120 reads “gtwyMIB.agent.ear2.sysName” as the OID out of the SNMP PDU.

Once the OID is read in the step 404, the SNMP gateway agent 120 primarily searches an upper OID in a step 406 to judge whether the OID is a gateway MIB or not. For instance, if the received SNMP packet is the SNMP packet for the SNMP gateway agent 120 itself instead of the SNMP agent 110, the upper OID in the read OID becomes another OID instead of the “gtwyM!B”. Thus, the SNMP gateway agent 120 judges whether the OID from the upper OID of the read OID is the SNMP packet for the SNMP agent 110 or the SNMP gateway agent 120 itself.

As a judging result of the step 406, if the upper OID of the read OID is the SNMP packet for the SNMP agent 110 as the gateway MIB (i.e., “gtwyMIB”), the SNMP gateway agent 120 searches the entire read OIDs stored previously therein from an OID agent address mapping table in a step 408 to find out an address of the corresponding SNMP agent 110. The SNMP gateway agent 120 then judges whether a read error (no data) occurs or not in a step 410. Namely, the SNMP gateway agent 120 searches the address of the corresponding SNMP agent 100 from the OID agent address mapping table having the entire read OIDs stored therein, as shown in FIG. 2. If the address exists, the SNMP gateway agent 120 carries out normal operation in the step 410. If not, the SNMP gateway agent 120 judges that an error occurs.

Moreover, as a judging result of the step 406, if the OID is not the gateway MIB (i.e., “gtwyMIB”) or the error occurs in the step 410, the SNMP packet received by the SNMP gateway agent 120 from the SNMP manager 100 becomes the SNMP packet for the SNMP gateway agent 120 itself. In this case, the SNMP gateway agent 120 treats the received SNMP packet in a step 414, generates an SNMP packet of TCP/IP as a result of treating the received SNMP packet in the step 414, and then transmits the generated SNMP packet to the SNMP manager 100 through the Internet network 130. Namely, the SNMP gateway agent 120 sets up its address of 192.168. 0. 2 as a source address and the address of the SNMP manager 100 of 192.168. 0. 1 as the target address to transmit the treated SNMP packet through the Internet network 130.

Thus, the SNMP manager 100 receives to treat the SNMP packet transmitted by the SNMP gateway agent 120 in a step 416.

Meanwhile, if the error does not occur in the step 410, the SNMP packet received by the SNMP gateway agent 120 becomes an SNMP packet for the SNMP agents 110. Hence, the SNMP gateway agent 120 transforms the received SNMP packet into another network protocol, i.e., a network protocol of the SNMP agents 110 in a step 418, and transmits the SNMP packet transformed into another network protocol to the SNMP agents 110 in a step 420. In this case, “192.168. 0. 2” as the address of the SNMP gateway agent 120 becomes the source address, and “01.02” as the address of the corresponding SNMP agent 110 read from the OID agent address mapping table becomes the target address.

In a step 422, the transmitted SNMP packet is treated by the SNMP agent 110 having the address of “01.02”. In a step 424, the SNMP agent 110 transmits the treated SNMP packet to the SNMP gateway agent 120. In this case, the SNMP agent 110 is unable to generate the SNMP packet of TCP/IP but generates the SNMP packet of a network protocol operating itself. Moreover, a source address of the generated SNMP packet becomes “0.1.02” of the address of the SNMP agent 110 and a target address becomes “192.168.0.2” of the address of the SNMP gateway agent 120.

In a step 426, the transmitted SNMP packet is received by the SNMP gateway agent 120 to transform into TCP/IP. In a step 428, the SNMP packet transformed into the TCP/IP is transmitted to the SNMP manager 100 through the Internet network 130. IN this case, a source address of the SNMP packet transformed into the TCP/IP is the “192.168.0.2” of the address of the SNMP gateway agent 120 itself, and a target address is “192.168.0.1” of the address of the SNMP manager 100.

In a step 430, the transmitted SNMP packet of TCP/IP is received by the SNMP manager 100 to treat.

Accordingly, the present invention enables to manage the TCP/IP based SNMP manager 100 and the SNMP agents 110 having another network protocol different from the TCP/IP without adding or modifying their functions. Moreover, the present invention enables to manage operations of a plurality of the SNMP agents 110 using the single IP (i.e., IP of the SNMP gateway agent 120) only, thereby being more effectively applicable to the case that IP addresses are limited or the number of the agents to be managed is great.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of managing networks operated by different protocols, comprising the steps of:
having an SNMP (simple network management protocol) gateway agent receive an SNMP packet generated by an SNMP manager;
having the SNMP gateway agent judge whether the SNMP packet received by the SNMP gateway agent is an SNMP packet for managing a plurality of SNMP agents operated by a network protocol different from that of the SNMP manager or not;
having the SNMP gateway agent transform the SNMP packet into the network protocol operating a plurality of the SNMP agents to transmit to a plurality of the SNMP agents if it is judged that the received SNMP packet is the SNMP packet for managing a plurality of the SNMP agents;
having a plurality of the SNMP agents treat the transmitted SNMP packet and transmitting the treated SNMP packet to the SNMP gateway agent;
having the SNMP gateway agent receive the transmitted SNMP packet, transforming the received SNMP packet into a protocol operating the SNMP manager, and transmitting the transformed SNMP packet to the SNMP manager; and
having the SNMP manager receive the transmitted SNMP packet to treat.

2. The method of claim 1, wherein the step of having the SNMP gateway agent judge is carried out based on an OID (object identification) that the SNMP gateway agent reads from the SNMP packet received from the SNMP manager.

3. The method of claim 2, wherein the SNMP gateway agent further reads an address of the corresponding SNMP agent that will transmit the SNMP packet from an OID agent address mapping table based on the read OID.

4. The method of claim 1, wherein the SNMP manager and the SNMP gateway agent transmit the SNMP packet reciprocally through a TCP/IP based Internet network.

5. A method of managing networks operated by different protocols, comprising:
a first step of having an SNMP (simple network management protocol) gateway agent receive an SNMP packet generated by an SNMP manager;
a second step of having the SNMP gateway agent judge whether the received SNMP packet is an SNMP packet for managing a plurality of SNMP agents operated by a network protocol different from that of the SNMP manager or not; and
a third step of having the SNMP gateway agent treat the SNMP packet to transmit the treated SNMP packet to the SNMP manager if it is judged that the received SNMP packet is an SNMP packet for the SNMP gateway agent itself.

6. The method of claim 5, wherein the second step is carried out based on an OID (object identification) that the SNMP gateway agent reads from the SNMP packet received from the SNMP manager.

7. The method of claim 5, wherein the SNMP manager and the SNMP gateway agent transmit the SNMP packet reciprocally through a TCP/IP based Internet network.

8. An apparatus for managing networks operated by different protocols, comprising:
a plurality of SNMP agents operated by a predetermined network protocol;
an SNMP manager managing operations of a plurality of the SNMP agents, the SNMP manager operated by another protocol different from the network protocol of a plurality of the SNMP agents; and
an SNMP gateway agent installed between the SNMP manager and a plurality of the SNMP agents, the SNMP gateway agent transforming a protocol of an SNMP packet transmitted reciprocally between the SNMP manager and a plurality of the SNMP agents to carry out an interfacing.

9. The apparatus of claim 8, wherein the SNMP gateway agent stores an OID agent address mapping table enabling an address of the corresponding SNMP agent of the received SNMP packet to be read based on an OID read from the SNMP packet received from the SNMP manager.
